(19) United States
(12) Patent Application Publication
(10) Pub. No.: US 2026/0267315 A1
(43) Pub. Date: Sep. 10, 2026

(54) SENSOR PLACEHOLDERS FOR THREE-DIMENSIONAL (3D) PRINTING

(71) Applicant: INTERNATIONAL BUSINESS MACHINES CORPORATION, Armonk, NY (US)

(72) Inventors: Tushar Agrawal, West Fargo, ND (US); Carolina Garcia Delgado, Zapopan (MX); Sarbajit Kumar Rakshit, Kolkata (IN); Randy A. Rendahl, Raleigh, NC (US)

(21) Appl. No.: 19/073,938

(22) Filed: Mar. 7, 2025

(51) Int. Cl. G05B 19/4099

(52) U.S. Cl. CPC G05B 19/4099; G05B 2219/49023

(57) ABSTRACT

A method, system, and computer program product configured to perform operations including: receiving a three-dimensional (3D) print file comprising a plurality of physical attributes describing an object to be 3D printed; determining historical data describing anticipated usage parameters and environmental parameters related to the object to be 3D printed; simulating the anticipated usage parameters and the anticipated environmental parameters related to the object to be 3D printed to identify a potential issue in at least one portion of the object to be 3D printed; determining a correction to the 3D print file based on the identified potential issue; determining a sensor for obtaining data related to the identified potential issue; modifying the 3D print file to include a placeholder for the sensor at a predetermined location; printing, using a 3D printer, the object to be 3D printed; and securing the sensor at the predetermined location.

### BACKGROUND

Aspects of the present invention relate generally to methods, systems, and computer program products for modeling 3D objects to be printed.

Objects can be 3D printed using various additive manufacturing technologies, where material is deposited layer by layer to create a physical object from a digital model. This process allows for the production of complex geometries and custom designs that may not be achievable with traditional manufacturing methods. 3D printing can be applied to a wide range of industries, including automotive, aerospace, healthcare, consumer products, and construction, enabling the creation of prototypes, functional parts, tools, and even end-use products with high precision and efficiency.

### SUMMARY

In a first aspect of the invention, there is a method including: receiving a three-dimensional (3D) print file comprising a plurality of physical attributes describing an object to be 3D printed; determining historical data describing anticipated usage parameters and environmental parameters related to the object to be 3D printed; simulating the anticipated usage parameters and the anticipated environmental parameters related to the object to be 3D printed to identify a potential issue in at least one portion of the object to be 3D printed; determining a correction to the 3D print file based on the identified potential issue; determining a sensor for obtaining data related to the identified potential issue; modifying the 3D print file to include a placeholder for the sensor at a predetermined location; printing, using a 3D printer, the object to be 3D printed; and securing the sensor at the predetermined location.

In another aspect of the invention, there is a computer program product comprising one or more computer-readable storage media and program instructions stored on the one or more computer-readable storage media to perform operations comprising: receiving a three-dimensional (3D) print file comprising a plurality of physical attributes describing an object to be 3D printed; determining historical data describing anticipated usage parameters and environmental parameters related to the object to be 3D printed; simulating the anticipated usage parameters and the anticipated environmental parameters related to the object to be 3D printed to identify a potential issue in at least one portion of the object to be 3D printed; determining a correction to the 3D print file based on the identified potential issue; determining a sensor for obtaining data related to the identified potential issue; modifying the 3D print file to include a placeholder for the sensor at a predetermined location; printing, using a 3D printer, the object to be 3D printed; and securing the sensor at the predetermined location.

In another aspect of the invention, there is a computer system comprising a processor set, one or more computer-readable storage media, and program instructions stored on the one or more computer-readable storage media to cause the processor set to perform operations comprising: receiving a three-dimensional (3D) print file comprising a plurality of physical attributes describing an object to be 3D printed; determining historical data describing anticipated usage parameters and environmental parameters related to the object to be 3D printed; simulating the anticipated usage parameters and the anticipated environmental parameters related to the object to be 3D printed to identify a potential issue in at least one portion of the object to be 3D printed; determining a correction to the 3D print file based on the identified potential issue; determining a sensor for obtaining data related to the identified potential issue; modifying the 3D print file to include a placeholder for the sensor at a predetermined location; printing, using a 3D printer, the object to be 3D printed; and securing the sensor at the predetermined location.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIGS. 4A-B show exemplary devices and considerations made by an exemplary method in accordance with aspects of the present invention.

### DETAILED DESCRIPTION

Aspects of the present invention relate generally to methods, systems, and computer program products for modeling 3D objects to be printed having placeholders for sensors and for placing sensors within and/or on a 3D object as it is printed. 3D printed objects experience various types of wear and tear, environmental erosion, and/or internal cracks can occur when in use. The extent of damage to 3D printed objects depends on environmental and usage factors. In conventional systems, 3D objects are printed with the environmental and usage factors in mind, but conventional systems do provide a method for obtaining 3D object data as it relates to the environmental and usage factors. Therefore, conventional systems suffer from a problem of not being able to track wear and tear, environmental erosion, and/or internal cracks caused by environmental and usage (i.e., operational) factors.

Implementations of the invention address this problem by providing a method, system, and computer program product that predicts the type(s) of wear and tear and/or damages that may occur on a 3D printed object and determines type(s) of sensors to be embedded in and/or on the 3D printed object. In this manner, implementations of the invention gather information and data for preventive maintenance planning. For example, based on the predicted types of damages, implementations of the invention identify types of sensors to be embedded on and/or in the 3D object and modifies a 3D model of the object to accommodate the identified sensors on and/or inside the 3D object. When embedded on and/or within the 3D object, the sensors gather and transmit data related to the performance of the 3D object over time.

According to an aspect of the present invention, the method, system, and computer program product include: identifying operational parameters and environmental parameters for a real-world location where a 3D printed object is to be used; predicting types of damage to the 3D printed object in the real-world location based on the operational parameters and the environmental parameters; identifying particular types of sensors to be embedded in the 3D printed object based on the predicted types of damage to the 3D printed object; and utilizing a robotic arm to attach the identified sensors to the 3D printed object.

In embodiments, the utilizing the robotic arm to attach the identified sensors to the 3D printed object includes utilizing the robotic arm to initialize the sensors attached to the 3D printed object based on a location of the sensors on or within the 3D printed object.

In embodiments, the predicting the types of damage to the 3D printed object includes modifying a 3D model file to accommodate the sensors.

In embodiments, the identifying the operational parameters and environmental parameters includes identifying a usage duration of the 3D printed object in the real-world location and identifying types of data to be collected by the sensors of the 3D printed object (e.g., temperature and dust concentration).

Implementations of the present invention are necessarily rooted in computer technology. For example, simulating the anticipated usage parameters and the anticipated environmental parameters related to the object to be 3D printed to identify a potential issue in at least one portion of the object to be 3D printed; determining a correction to the 3D print file based on the identified potential issue; modifying the 3D print file to include a placeholder for a sensor at a predetermined location; printing, using a 3D printer, the object to be 3D printed; and securing the sensor at the predetermined location are computer-based and cannot be performed in the human mind.

It should be understood that, to the extent implementations of the present invention collect, store, or employ personal information provided by, or obtained from, individuals (e.g., information captured using sensors embedded within a 3D-printed object being used by the individual), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as novel 3D modeling and printing code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

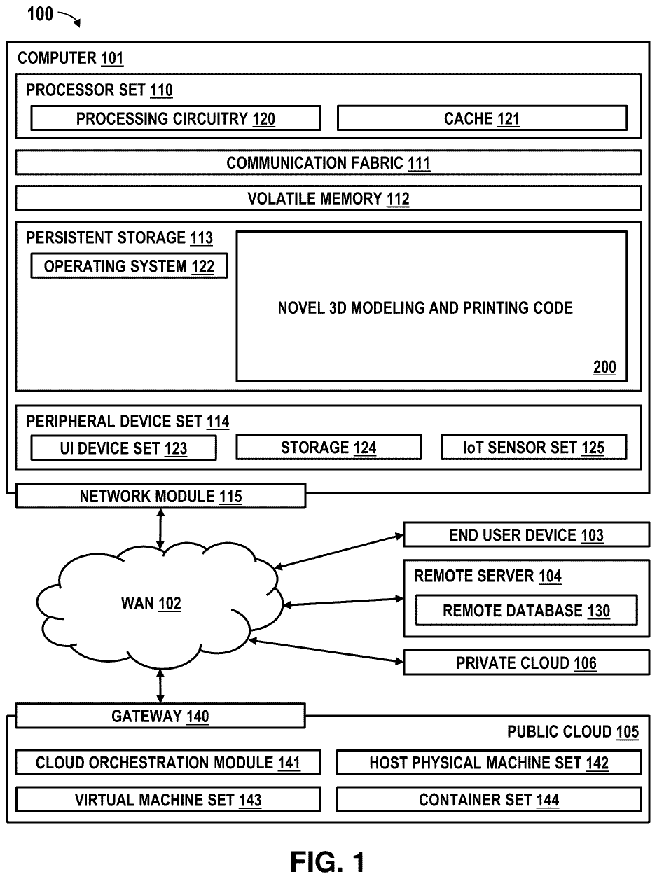

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

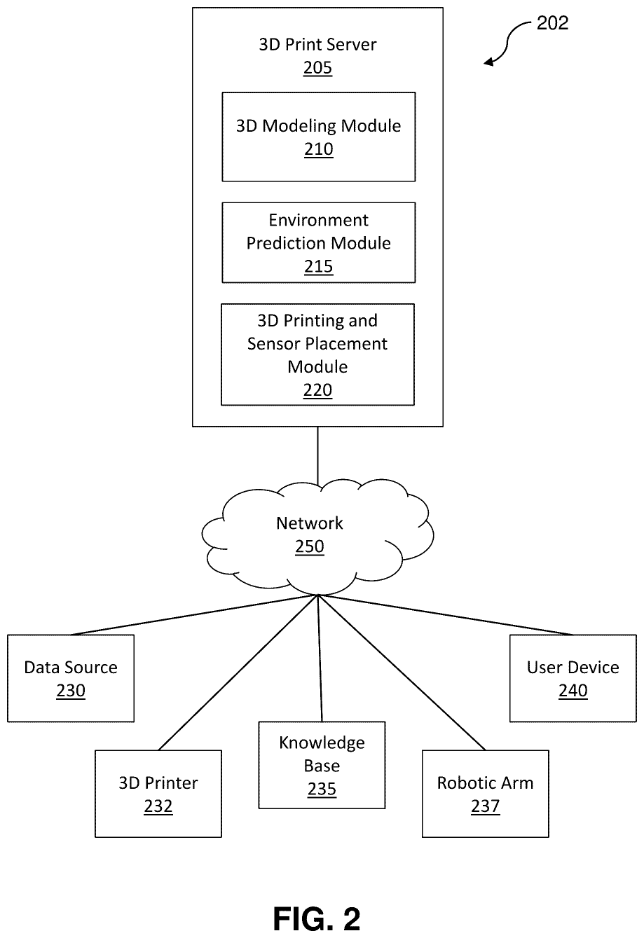

FIG. 2 shows a block diagram of exemplary environment 202 in accordance with aspects of the present invention. In embodiments, environment 202 includes 3D print server 205, data source 230, 3D printer 232, knowledge base 235, robotic arm 237, user device 240, and network 250.

3D print server 205 may comprise one or more instances of computer 101 of FIG. 1. In another example 3D print server 205 may comprise one or more virtual machines or containers running on one or more instances of computer 101 of FIG. 1. In embodiments, 3D print server 205 communicates with data source 230, 3D printer 232, knowledge base 235, robotic arm 237, and user device 240 via network 250, which may comprise WAN 102 of FIG. 1. In embodiments, data source 230 may comprise one or more data sources each comprising an instance of remote database 130 and/or remote server 104 of FIG. 1. In embodiments, 3D printer 232 may comprise one or more 3D printers capable of receiving a 3D print file from print server 205 and capable of 3D printing an object based on the 3D print file. In embodiments, 3D printer 232 may be local to 3D print server 205. In embodiments, knowledge base 235 may comprise one or more data sources each comprising an instance of remote database 130 and/or remote server 104 of FIG. 1. In embodiments, robotic arm 237 may comprise one or more robotic arms capable of holding objects during a 3D print and/or attaching an object to a 3D printed device. In embodiments, the robotic arm 237 may be local to 3D print server 205. In embodiments, user device 240 comprises an instance of EUD 103 of FIG. 1. There may be plural different instances of user device 240 including, for example, personal computing devices and/or any other device useful for generating and/or storing spatial computing information as disclosed herein. The different instances of user device 240 may be used by different users, evaluators, operators, technicians, etc.

In embodiments, 3D print server 205 of FIG. 2 comprises 3D modeling module 210, environment prediction module 215, and 3D printing and sensor placement module 220, each of which may comprise modules of the code of block 200 of FIG. 1. Such modules may include routines, programs, objects, components, logic, data structures, and so on that perform a particular task (or tasks) or implement a particular data type (or types) that the code of block 200 uses to carry out the functions and/or methodologies of embodiments of the present invention as described herein. These modules of the code of block 200 are executable by computer 101 of FIG. 1 (e.g., processing circuitry 120 of FIG. 1) to perform the inventive methods as described herein. 3D print server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, 3D print server 205 is configured to facilitate communication between 3D modeling module 210, environment prediction module 215, 3D printing and sensor placement module 220, and external storage (e.g., data source 230 and/or knowledge base 235) and devices (e.g., user device 240) via network 250. For example, in embodiments, 3D print server 205 may receive, access, and/or obtain the 3D print file describing an object to be 3D printed from external storage (e.g., data source 230 and/or knowledge base 235).

In accordance with aspects of the present invention, 3D modeling module 210 may be configured to scan a pre-manufactured object to determine physical attributes of the pre-manufactured object. As used herein, scanning refers to the process of capturing the shape, dimensions, surface texture, color information, geometry accuracy, surface smoothness, surface contours, and/or other relevant physical properties of the object. In embodiments, 3D modeling module 210 performs that scanning using laser scanning techniques, cameras, structured light, photogrammetry, and/or any other scanning technology capable of capturing the shape and dimensions of an object. As used herein, a pre-manufactured object refers to an object that has been created, fabricated, and/or assembled prior to the scanning process. In embodiments, the pre-manufactured object may be a 3D printed object. In embodiments, scanning is performed using laser scanning, cameras, structured light, photogrammetry, and/or any other scanning technology capable of capturing the shape and dimensions of an object.

In embodiments 3D modeling module 210 is configured to analyze the scan data to determine scan resolution, scan noise, scan artifacts, areas of reflectivity, areas of transparency, scan scale, scan proportions, and other factors that may negatively affect the quality of the scan. In such embodiments, 3D modeling module 210 may filter and/or modify the scan based on the analysis, by removing or correcting errors, smoothing surfaces, adjusting scale, and enhancing resolution or detail where necessary.

In embodiments, 3D modeling module 210 is configured to generate, obtain, and/or receive a 3D print file comprising the plurality of physical attributes describing the object to be 3D printed based on the scanning results. In other words, 3D modeling module 210 may be configured to generate a 3D print file by processing the scan data to create a digital 3D model, which includes the object's shape, dimensions, surface texture, and other relevant attributes, and then converting this model into a file format suitable for 3D printing (e.g., stereolithography file (STL), object file (OBJ), and/or additive manufacturing file (AMF)). In embodiments, the 3D print file may be stored locally and/or in an external storage (e.g., data source 230 and/or knowledge base 235).

In embodiments, 3D modeling module 210 may obtain and/or receive a 3D print file from a database (e.g., data source 230) and/or a historical corpus (e.g., knowledge base 235). In such embodiments, 3D modeling module 210 may access the databased and/or historical corpus via a network (e.g., network 250) to download the 3D print file. In other embodiments, 3D modeling module 210 may receive the 3D print file in response to a request for the 3D print file.

In embodiments, 3D modeling module 210 may obtain and/or receive specifications for one or more sensors and/or types of sensors to be embedded within and/or place on a 3D objection. In embodiments, 3D modeling module 210 receives the specifications for one or more sensors and/or types of sensors from environment prediction module 215.

In embodiments, 3D modeling module 210 is configured to alter and/or modify the 3D print file to include placeholders for the sensors and/or types of sensors at locations for obtaining data related to potential issues and/or environmental factors that the 3D object may be exposed to. For example, in embodiments, 3D modeling module 210 is configured to adjust the contents of the 3D print file to facilitate the placement of the sensor and determine the optimal timing during the 3D print process for sensor insertion. In such embodiments, this includes ensuring that the printing process can proceed without interference from the sensor placement. 3D modeling module 210 may further ensure that an opening is maintained in the object design, allowing the sensor to be placed without obstruction. In embodiments, the modified 3D print design includes support structures that secure the sensor in place as the remaining portions of the object are printed, ensuring the sensor remains firmly in position. Furthermore, in embodiments, 3D modeling module 210 is configured to generate a synchronized model that incorporates both an ongoing 3D print job and a sensor placement using a robotic arm (e.g., one or more instances of robotic arm 237), ensuring coordination between the printing process and sensor integration. In embodiments, the sensor may be placed by the robotics arm and/or a user after the 3D object is printed.

In accordance with aspects of the present invention, environment prediction module 215 is configured to determine, identify, and/or receive historical data describing anticipated usage (i.e., operational) and/or environmental parameters of the object to be 3D printed. As used herein, usage parameters for the 3D object refer to the intended or expected functions, loads, stresses, and/or other conditions the object will experience during its use as well as performance characteristics of the 3D object during its operation. In embodiments, usage parameters may include frequency of use, movement, and/or interaction with other components, materials, speed, power consumption, repetitions, rotations, operational cycles, specific performance criteria that the 3D object must meet under various conditions, and more. As used herein, environmental parameters for the 3D object refer to external conditions and/or environments the 3D object will be exposed to during its operation, such as temperature, humidity, pressure, chemical exposure, and other environmental factors that could affect its performance or durability.

In embodiments, environment prediction module 215 may access and/or obtain a historical corpus for 3D object designs related to the 3D object to be printed. In such embodiments, the historical corpus may include, for example, failure timeframes, usage environment conditions, details of maintenance designed to avoid failure, relative expense, availability impact of maintenance versus failure, and more. In embodiments, where the historical corpus for 3D object designs related to the 3D object to be printed is small (or non-existent), environment prediction module 215 may analyze historical results for other print patterns that have a similar design. For example, environment prediction module 215 may perform an operational analysis as a proxy using the similar design. In such embodiments, environment prediction module 215 may update the proxy analysis as historical data becomes available for the actual 3D object to be printed.

In embodiments, environment prediction module 215 is configured to simulate an anticipated usage, operational, and/or environmental parameters of the object to be 3D printed to identify potential issues in one or more portions of the object to be 3D printed. For example, environment prediction module 215 may simulate how the object will perform under varying temperature conditions to identify areas where the material might weaken and/or deform, or it could simulate stress concentrations in areas of the object that may be subject to high mechanical loads, helping to predict potential structural failures.

In embodiments, environment prediction module 215 may design simulations to test for, and identify, potential issues such as layer separation (e.g., layers can separate, leading to structural weakness), warping (e.g., heat variations and/or improper cooling can cause the object to warp and/or deform), cracking (e.g., high-stress areas or structural weaknesses can result in cracks in the printed object), delamination (e.g., in multi-material prints, different layers may separate and/or delaminate), overhang failure (e.g., unsupported and/or steep overhangs may lead to sagging and/or collapsing sections), material degradation (e.g., exposure to certain environmental conditions, such as high temperatures and/or ultra-violet (UV) light, can cause a material to degrade over time), and more.

In embodiments, environment prediction module 215 performs simulations for the 3D object as a whole. In other embodiments, environment prediction module 215 performs simulations for specific and/or each portion, zone, and/or feature of the 3D object. For example, if a 3D object has two portions, zones, and/or features, the simulation may include the entire object, the first portion, zone, and/or feature, and/or the second portion, zone, and/or feature. In embodiments, the simulation may be performed using a digital twin. For example, the digital twin can virtually replicate the physical properties and/or environmental interactions of the 3D object, enabling the prediction of potential issues such as material behavior, stress distribution, the impact of external factors like temperature fluctuations and/or humidity, and more.

Through the foregoing simulations, the environment prediction module 215 ensures the reliability and durability of 3D printed objects by simulating various usage, operational, and environmental conditions. By identifying potential issues such as material deformation, structural weaknesses, and failure modes before the printing process begins, it enables more informed decision-making and the optimization of the 3D printing design, including optimization of the 3D object as a whole and/or optimization of specific and/or each portion, zone, and/or feature of the 3D object. This proactive approach helps to enhance the performance, longevity, and overall quality of 3D printed objects, ultimately reducing the risk of post-production issues and improving the efficiency of the manufacturing process.

In embodiments, environment prediction module 215 is configured to determine and/or identify corrections, maintenance, and/or preventative maintenance based on the identified potential issues. For example, if the simulations provide that the 3D object design would not adequately perform under intense heath and/or UV light, environment prediction module 215 may modify the 3D print file to select a more suitable material with better heat resistance or UV stability, adjust the design to include reinforcements in vulnerable areas, and/or modify the printing process parameters (e.g., print speed, materials, layers, etc.) to enhance the durability of the 3D object under those conditions.

In embodiments, environment prediction module 215 is configured to determine and/or identify sensors and/or types of sensors for obtaining data related to the identified potential issues and/or based on historical data. As used herein, identifying sensors and/or types of sensors refers to the process of selecting and specifying appropriate sensors that can monitor and collect data related to the identified potential issues and/or environmental conditions. Types of sensors embedded in and/or placed on the 3D object may include, for example, temperature sensors to monitor heat variations, humidity sensors to track moisture levels, stress and/or strain gauges to measure mechanical deformation, UV sensors to detect exposure to ultraviolet radiation, pressure sensors to monitor external forces, vibration sensors to assess structural integrity, and accelerometers and/or gyroscopes to detect movement and/or orientation changes, all of which can provide critical data to evaluate the object's performance under specific environmental and operational conditions.

For example, if environment prediction module 215 determined that humidity may be a potential issue for a specific portion of the 3D object, environment prediction module 215 will determine and/or identify a sensor (or sensors) that can be embedded within and/or placed on the 3D object to monitor humidity at the specific portion of the 3D object. In the same example, if environment prediction module 215 determined that friction may be a potential issue for a second (i.e., a different) portion of the 3D object, environment prediction module 215 will determine and/or identify a sensor (or sensors) that can be embedded within and/or placed on the 3D object to monitor heat and/or friction at the second portion of the 3D object. In embodiments, one 3D object may have one or more sensors to track and/or monitor several different parameters.

In embodiments, environment prediction module 215 determines the location best suited to measuring the usage and environmental parameters. For example, if 3D modeling module 210 used a proxy model, environment prediction module 215 may correlate the location in the proxy model to the current model to determine the equivalent location in the 3D object to be printed. In embodiments, such locations may be exposure points for elements (salt, water, heat, humidity, etc.) as well as key stress points impacted by varying usage patterns or conditions. In embodiments, locations are evaluated to ensure the sensor will fit and be able to sense properly. For example, some sensors may need to have an exposed surface to measure specific environmental conditions. In embodiments, the locations and sensor specifications may be shared with 3D modeling module 210, so 3D modeling module 210 can update, modify, and/or alter the 3D print file to accommodate the placement of the sensors and/or types of sensors within and/or on the 3D object to be printed.

In embodiments, environment prediction module 215 may consider and/or assess the impact of maintenance versus failure to determine if a sensor is worth embedding. For example, environment prediction module 215 may assess a relative cost of repair versus maintenance, down time for repair versus maintenance, increase in downtime due to proactive maintenance against waiting for failure, cost of sensor and/or monitoring system is compared to savings when using the sensor, and more. In embodiments, environment prediction module 215 may further assess the potential for detecting early signs of failure through the sensor, the impact of sensor data on improving operational efficiency, and the ability to prevent catastrophic failures and/or expensive repairs by providing real-time monitoring, ultimately determining whether using the sensor(s) provides sufficient return on investment and enhances the overall lifecycle management of the 3D printed object.

In embodiments, environment prediction module 215 may determine a predicted time to perform a preventative maintenance activity based on the types of sensors, the anticipated usage parameters, and the anticipated environmental parameters. For example, environment prediction module 215 may analyze data from temperature, humidity, and stress sensors to predict when a 3D printed object is likely to experience wear and/or failure due to prolonged exposure to high temperatures or mechanical stress. In embodiments, based on this data, the module estimates the optimal time to perform preventative maintenance to extend the object's operational lifespan.

In embodiments, environment prediction module 215 is configured to store data related to the 3D printed object in a historical corpus (e.g., knowledge base 235). In embodiments, any data received regarding ongoing maintenance, failures, etc., may be collected and saved to further the corpus for subsequent print jobs. For example, environment prediction module 215 may look for changes in the rate of failure negating sensor success, new conditions that impact reliability, updates from the proxy model to the real model, changes in cost and/or value, actual maintenance behaviors, and more.

In accordance with aspects of the present invention, 3D printing and sensor placement module 220 is configured to print the object to be 3D printed based on the 3D print file. For example, 3D printing and sensor placement module 220 may print the object layer by layer, while simultaneously embedding or placing sensors at strategic locations, such as within structural supports, high-stress areas, or regions where environmental factors are expected to impact the object.

In embodiments, 3D printing and sensor placement module 220 uses a robotic arm (e.g., one or more instances of robotic arm 237) to attach, secure, and/or initialize the sensors and/or types of sensors at locations specified by the 3D print file. For example, the robotic arm may position and secure temperature and/or strain sensors directly onto the 3D object's surface and/or within its internal structure, based on the design parameters specified by the 3D print file, ensuring that the sensors are accurately placed to monitor the object's performance during its intended usage.

In embodiments, 3D printing and sensor placement module 220 is configured to synchronize a robotic arm (e.g., one or more instances of robotic arm 237) with the 3D printing. In such embodiments, 3D printing and sensor placement module 220 will control the robotic arm (or cause the robotic arm to be controlled) at appropriate points in the printing process where a sensor placement is indicated in the 3D print file. The robotic arm may then select the designated sensor, identify the target location and place the sensor. In embodiments, the robotic arm may place the sensor and apply and/or incorporate adhesives to ensure the sensor remains in place during the print job. In embodiments, the robotic arm may hold the sensor in place while the 3D print process continues.

In embodiments, 3D printing and sensor placement module 220 may print a circuit (e.g., conductive traces and/or wiring) connecting the sensors to each other, a power source, and/or a processor. For example, 3D printing and sensor placement module 220 may be configured to print conductive traces and/or wiring directly onto the 3D object and/or within designated channels to create a circuit that connects the embedded sensors to one another, to an external power source, and/or to a processor for communicating the data to an external system. In embodiments, this may involve printing a flexible and/or rigid conductive material that ensures seamless communication between the sensors and enables the efficient transmission of data during the object's operation.

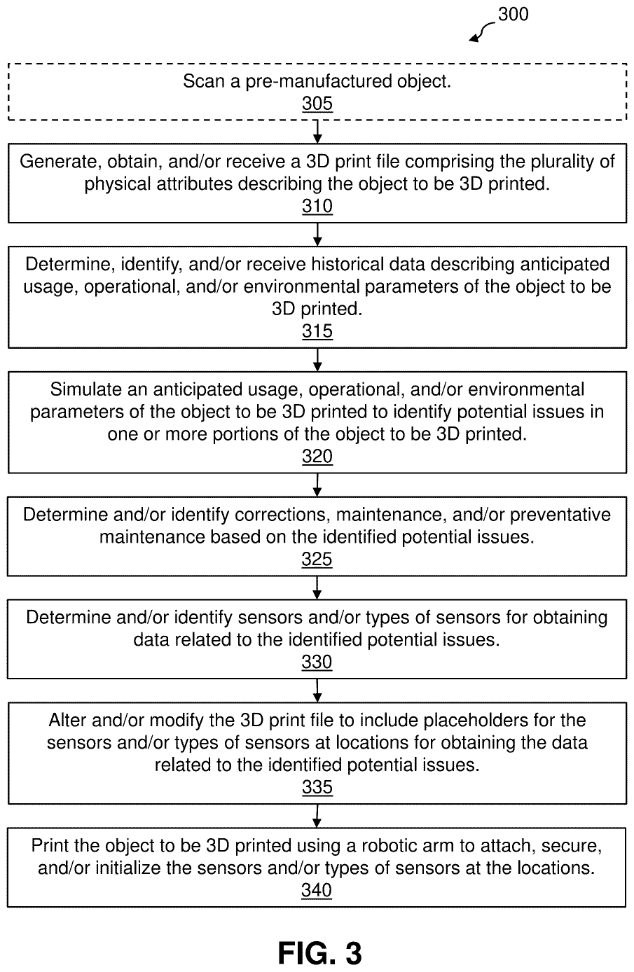

FIG. 3 shows a flow diagram of an exemplary method 300 in accordance with aspects of the present invention. Operations of the method 300 are described with reference to elements and actions depicted in and described with reference to FIG. 2.

At operation 305, the system (e.g., 3D modeling module 210 of FIG. 2) may be optionally configured (as indicated by the dotted lines) to scan a pre-manufactured object. As provided above, scanning refers to the process of capturing the shape, dimensions, surface texture, color information, geometry accuracy, surface smoothness, surface contours, and/or other relevant physical properties of the object. Furthermore, a pre-manufactured object refers to an object that has been created, fabricated, and/or assembled prior to the scanning process. In embodiments, the pre-manufactured object may be a 3D printed object. Operation 305 may be performed in accordance with the descriptions and embodiments of 3D modeling module 210 and with respect to FIG. 2.

At operation 310, the system (e.g., 3D modeling module 210 of FIG. 2) is configured to generate, obtain, and/or receive a 3D print file comprising the plurality of physical attributes describing the object to be 3D printed. In embodiments, 3D modeling module 210 is configured to generate a 3D print file by processing the scan data to create a digital 3D model, which includes the object's shape, dimensions, surface texture, and other relevant attributes. In such embodiments, 3D modeling module 210 converts this digital 3D model into a file format suitable for 3D printing (e.g., stereolithography file (STL), object file (OBJ), and/or additive manufacturing file (AMF)). Operation 310 may be performed in accordance with the descriptions and embodiments of 3D modeling module 210 and with respect to FIG. 2.

At operation 315, the system (e.g., environment prediction module 215 of FIG. 2) is configured to determine, identify, and/or receive historical data describing anticipated usage, operational, and/or environmental parameters of the object to be 3D printed. As noted above, in embodiments, environment prediction module 215 may access and/or obtain a historical corpus (e.g., knowledge base 235 of FIG. 2) for 3D object designs related to the 3D object to be printed. In such embodiments, the historical corpus may include, for example, failure timeframes, usage environment conditions, details of maintenance designed to avoid failure, relative expense, availability impact of maintenance versus failure, and more. Operation 315 may be performed in accordance with the descriptions and embodiments of environment prediction module 215 with respect to FIG. 2.

At operation 320, the system (e.g., environment prediction module 215 of FIG. 2) is configured to simulate an anticipated usage, operational, and/or environmental parameters of the object to be 3D printed to identify potential issues in one or more portions of the object to be 3D printed. For example, as provided above, environment prediction module 215 may simulate how the object will perform under varying conditions to identify areas where the material might weaken, deform, fail, etc. Operation 320 may be performed in accordance with the descriptions and embodiments of environment prediction module 215 with respect to FIG. 2.

At operation 325, the system (e.g., environment prediction module 215 of FIG. 2) is configured to determine and/or identify corrections, maintenance, and/or preventative maintenance based on the identified potential issues. For example, as provided above, if the simulations provide that the 3D object design would not adequately perform under a specific condition, environment prediction module 215 may modify the 3D print file to select a more suitable material to enhance the functionality of the 3D object under those conditions. Operation 325 may be performed in accordance with the description and embodiments of environment prediction module 215 and with respect to FIG. 2.

At operation 330, the system (e.g., environment prediction module 215 of FIG. 2) is configured to determine and/or identify sensors and/or types of sensors for obtaining data related to the identified potential issues, based on historical data. As described above, identifying sensors and/or types of sensors refers to the process of selecting and specifying appropriate sensors that can monitor and collect data related to the identified potential issues and/or environmental conditions. In embodiments environment prediction module 215 may provide the identified sensors and/or types of sensors, including a location for placing the sensors and/or types of sensors within and/or on the 3D object to be printed, to 3D modeling module 210. Operation 330 may be performed in accordance with the description and embodiments of environment prediction module 215 and with respect to FIG. 2.

At operation 335, the system (e.g., 3D modeling module 210 of FIG. 2) is configured to alter and/or modify the 3D print file to include placeholders for the sensors and/or types of sensors at locations for obtaining the data related to the identified potential issues. In other words, as described above, 3D modeling module 210 is configured to adjust the contents of the 3D print file to facilitate the placement of the sensor and determine the optimal timing during the 3D print process for sensor insertion. Operation 335 may be performed in accordance with the description and embodiments of 3D modeling module 210 and with respect to FIG. 2.

At operation 340, the system (e.g., 3D printing and sensor placement module 220) is configured to print the object to be 3D printed using a robotic arm (e.g., robotic arm 237 of FIG. 2) to attach, secure, and/or initialize the sensors and/or types of sensors at the locations. In embodiments, the system employs a local and/or external 3D printer (e.g., 3D printer 232) to print the object. In embodiments, printing the object further includes printing electric circuits that connect the types of sensors with one another, with a power source, and/or a processor for transmitting the data to an external processor. Operation 440 may be performed in accordance with the description and embodiments of 3D printing and sensor placement module 220 and with respect to FIG. 2.

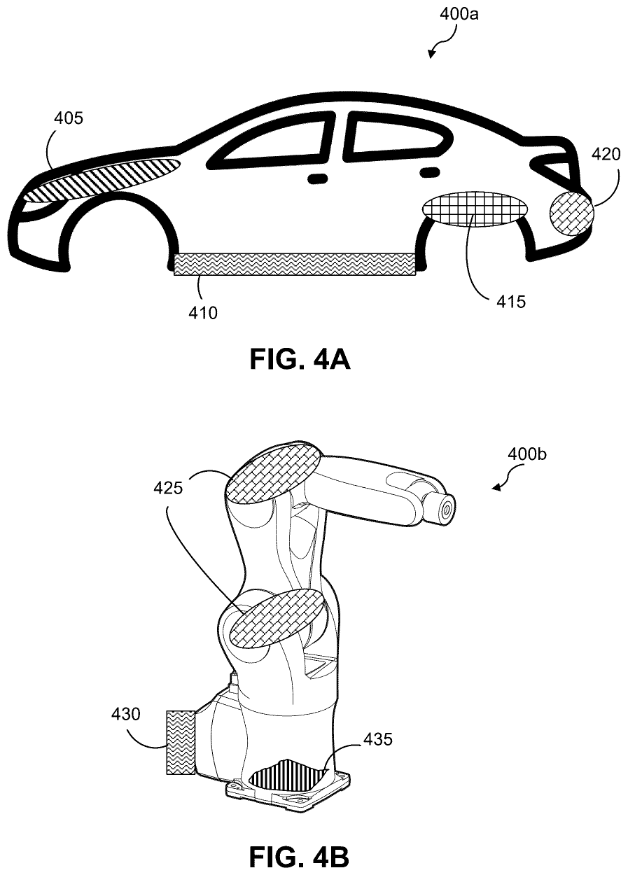

FIG. 4A shows an exemplary device 400a subjected to aspects of the present invention. Determinations and placement of sensors within device 400a may be carried out in the environment of FIG. 2 and are described with reference to elements depicted in FIGS. 2 and 3.

As illustrated, device 400a comprises a body of a car to be 3D printed, the body of the car comprises four locations: under the hood 405, undercarriage 410, wheel well 415, and rear bumper 420. In this example, components located under the hood 405 of a car may be subject to high temperature fluctuations and mechanical stress due to engine operation. Accordingly, the system (e.g., environment prediction module 215 of FIG. 2) may determine that a temperature and/or strain sensor should be embedded within the hood of the car as it is 3D printed. Doing so may provide an estimated future schedule for performing preventative maintenance on 3D printed components located under the hood 405 of the car, based on real-time data gathered from the sensors monitoring temperature variations and mechanical stress during operation.

Components located on the undercarriage 410 of a car may be subjected to salt, moisture, abrasion, and corrosive elements from road surfaces. Accordingly, the system (e.g., environment prediction module 215 of FIG. 2) may determine that a corrosion and/or moisture sensor should be embedded within/or on the undercarriage 410 of the car as it is 3D printed. Doing so may provide an estimated future schedule for performing preventative maintenance on 3D printed components located within/or on the undercarriage 410 of the car, based on real-time data gathered from the sensors monitoring moisture levels, corrosion, and physical wear during operation.

Components located on wheel well 415 of a car may be subjected to road debris, high-impact forces, and exposure to water, dirt, and chemicals. Accordingly, the system (e.g., environment prediction module 215 of FIG. 2) may determine that a stress, impact, and/or moisture sensor should be embedded within/or on the wheel well 415 of the car as it is 3D printed. Doing so may provide an estimated future schedule for performing preventative maintenance on 3D printed components located within/or on the wheel well 415 of the car, based on real-time data gathered from the sensors monitoring impact forces, moisture levels, and structural stress during operation.

Components located on rear bumper 420 of a car may be subjected to abrasion, impacts from low-speed collisions, and exposure to varying environmental conditions, including UV light. Accordingly, the system (e.g., environment prediction module 215 of FIG. 2) may determine that a UV light and/or impact sensor should be embedded within/or on the rear bumper 420 of the car as it is 3D printed. Doing so may provide an estimated future schedule for performing preventative maintenance on 3D printed components located within/or on the rear bumper 420 of the car, based on real-time data gathered from the sensors monitoring UV exposure, impact forces, and material degradation during operation.

FIG. 4B shows an exemplary device 400b subjected to aspects of the present invention. Determinations and placement of sensors within device 400a may be carried out in the environment of FIG. 2 and are described with reference to elements depicted in FIGS. 2 and 3.

As illustrated device 400b comprises an arm of a robotic paint spraying device to be 3D printed, the robotic paint spraying device comprises four locations: joints 425, paint intake port 430, and base 435. In this example, components located at joints 425 of a robotic paint spraying device may be subject to high mechanical stress, friction, and wear due to repetitive movement. Accordingly, the system (e.g., environment prediction module 215 of FIG. 2) may determine that a strain and wear sensor should be embedded within joints 425 of the robotic paint spraying device as they are 3D printed. Doing so may provide an estimated future schedule for performing preventative maintenance on 3D printed components located within joints 425 of the robotic paint spraying device, based on real-time data gathered from the sensors monitoring strain, friction, and mechanical wear during operation.

Components located at paint intake port 430 of a robotic paint spraying device may be subject to chemical exposure, clogging, and wear from paint flow. Accordingly, the system (e.g., environment prediction module 215 of FIG. 2) may determine that a chemical exposure and flow sensor should be embedded within the paint intake port 430 of a robotic paint spraying device as it is 3D printed. Doing so may provide an estimated future schedule for performing preventative maintenance on 3D printed components located within paint intake port 430 of the robotic paint spraying device, based on real-time data gathered from the sensors monitoring paint flow, clogging, and chemical degradation during operation.

Components located at base 435 of a robotic paint spraying device may be subject to vibration, impacts, and exposure to external environmental conditions. Accordingly, the system (e.g., environment prediction module 215 of FIG. 2) may determine that a vibration and environmental stress sensor should be embedded within and/or on base 435 of the robotic paint spraying device as it is 3D printed. Doing so may provide an estimated future schedule for performing preventative maintenance on 3D printed components located within and/or on base 435 of the robotic paint spraying device, based on real-time data gathered from the sensors monitoring vibration, impacts, and environmental stress during operation.

While a body of a car is depicted in FIG. 4A and a robotic paint spraying device is depicted in FIG. 4B, the methods, systems, and computer program products described herein can be applied to any object to be 3D printed that is large enough to hold, carry, and/or encompass a sensor. Similarly, the methods, systems, and computer program products described herein can be applied to any object that can be 3D printed, including building components, aircraft parts, industrial machinery, consumer products, medical devices, structural elements in infrastructure projects, and more.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a three-dimensional (3D) print file comprising a plurality of physical attributes describing an object to be 3D printed;
determining historical data describing anticipated usage parameters and environmental parameters related to the object to be 3D printed;
simulating the anticipated usage parameters and the anticipated environmental parameters related to the object to be 3D printed to identify a potential issue in at least one portion of the object to be 3D printed;
determining a correction to the 3D print file based on the identified potential issue;
determining a sensor for obtaining data related to the identified potential issue;
modifying the 3D print file to include a placeholder for the sensor at a predetermined location;
printing, using a 3D printer, the object to be 3D printed; and
securing the sensor at the predetermined location.

2. The method of claim 1, further comprising:
scanning a pre-manufactured object; and
generating the 3D print file comprising the plurality of physical attributes describing the object to be 3D printed based on the scanning.

3. The method of claim 1, wherein the predetermined location is determined based on a location for obtaining the data related to the identified potential issue.

4. The method of claim 1, wherein simulating the anticipated usage parameters and anticipated environmental parameters of the object to be 3D printed further comprises simulating anticipated operational parameters of the object to be 3D printed.

5. The method of claim 4, wherein the anticipated usage parameters comprise one or more usage parameters selected from a group consisting of: load, stress, frequency of use, movement, interaction with other components, materials, speed, power consumption, and operation cycle.

6. The method of claim 1, wherein the anticipated environmental parameters comprise one or more environmental parameters selected from a group consisting of: temperature, humidity, pressure, and chemical exposure.

7. The method of claim 1, wherein the sensor comprises one or more sensors selected from a group consisting of: a temperature sensor, a humidity sensor, a stress gauge, a strain gauge, an ultra-violet (UV) sensor, a pressure sensor, a vibration sensor, and an accelerometer.

8. The method of claim 1, wherein the printing the object to be 3D printed comprises embedding the sensors within the object to be 3D printed.

9. The method of claim 1, wherein the printing the object to be 3D printed comprises printing electric circuits that connect the sensor with a processor.

10. The method of claim 9, further comprising determining a predicted time to perform a preventative maintenance activity based on the sensor, the anticipated usage parameters, and the anticipated environmental parameters.

11. The method of claim 1, wherein the securing the sensor at the predetermined location comprises attaching the sensor at the predetermined location using a robotic arm.

12. A computer program product comprising:
one or more computer-readable storage media; and
program instructions stored on the one or more computer-readable storage media to perform operations comprising:
receiving a three-dimensional (3D) print file comprising a plurality of physical attributes describing an object to be 3D printed;
determining historical data describing anticipated usage parameters and environmental parameters related to the object to be 3D printed;
simulating the anticipated usage parameters and the anticipated environmental parameters related to the object to be 3D printed to identify a potential issue in at least one portion of the object to be 3D printed;
determining a correction to the 3D print file based on the identified potential issue;
determining a sensor for obtaining data related to the identified potential issue;
modifying the 3D print file to include a placeholder for the sensor at a predetermined location;
printing, using a 3D printer, the object to be 3D printed; and
securing the sensor at the predetermined location.

13. The computer program product of claim 12, wherein the operations further comprise:
scanning a pre-manufactured object; and
generating the 3D print file comprising the plurality of physical attributes describing the object to be 3D printed based on the scanning.

14. The computer program product of claim 12, wherein simulating the anticipated usage parameters and anticipated environmental parameters of the object to be 3D printed further comprises simulating anticipated operational parameters of the object to be 3D printed.

15. The computer program product of claim 12, wherein the securing the sensor at the predetermined location comprises attaching the sensor at the predetermined location using a robotic arm.

16. A computer system comprising:
a processor set;
one or more computer-readable storage media; and
program instructions stored on the one or more computer-readable storage media to cause the processor set to perform operations comprising:
receiving a three-dimensional (3D) print file comprising a plurality of physical attributes describing an object to be 3D printed;
determining historical data describing anticipated usage parameters and environmental parameters related to the object to be 3D printed;
simulating the anticipated usage parameters and the anticipated environmental parameters related to the object to be 3D printed to identify a potential issue in at least one portion of the object to be 3D printed;
determining a correction to the 3D print file based on the identified potential issue;
determining a sensor for obtaining data related to the identified potential issue;
modifying the 3D print file to include a placeholder for the sensor at a predetermined location;
printing, using a 3D printer, the object to be 3D printed; and
securing.

17. The computer system of claim 16, wherein the operations further comprise:
scanning a pre-manufactured object; and
generating the 3D print file comprising the plurality of physical attributes describing the object to be 3D printed based on the scanning.

18. The computer system of claim 16, wherein the printing the object to be 3D printed comprises embedding the sensors within the object to be 3D printed.

19. The computer system of claim 16, wherein the printing the object to be 3D printed comprises printing electric circuits that connect the sensor with a processor.

20. The computer system of claim 16, wherein the operations further comprise determining a predicted time to perform a preventative maintenance activity based on the sensor, the anticipated usage parameters, and the anticipated environmental parameters.
